(19) United States
(12) Patent Application Publication
(10) Pub. No.: US 2010/0045155 A1
(43) Pub. Date: Feb. 25, 2010

(54) EL Panel with Thermally Rear Electrode

(75) Inventor: Richard Allen Padilla, Queen Creek, AZ (US)

Correspondence Address: CANTOR COLBURN, LLP, 20 Church Street, 22nd Floor, Hartford, CT, 06103, US

(73) Assignee: WORLD PROPERTIES, INC., Lincolnwood, IL (US)

(21) Appl. No.: 12/517,174

(22) PCT Filed: Nov. 29, 2007
(86) PCT No.: PCT/US07/24602

§ 371 Date: Jun. 1, 2009

Related U.S. Application Data
(60) Provisional application No. 60/872,237, filed on Dec. 1, 2006.

(51) Int. Cl. H05B 33/02; B32B 37/06

(52) U.S. Cl. 313/1; 313/506; 156/272.8

(57) ABSTRACT

An EL panel includes a conductive layer that is thermally bonded to portions of the panel. A patterned rear electrode can be reconfigured easily for prototype or low volume production yet the method and apparatus are suitable for volume production as well. The rear electrode is patterned by raster scanning a localized heating element or by using toner powder as the adhesive, wherein the toner powder is patterned by xerographic printing.

Applicant claims the benefit of the filing date of Provisional Application No. 60/872,237, filed Dec. 1, 2006, and incorporated herein by reference.

### BACKGROUND TO THE INVENTION

This invention relates to thick film electroluminescent (EL) lamps and, in particular, to an EL panel having a rear electrode that is thermally transferred to the panel.

As used herein, an EL “panel” is a single substrate including one or more luminous areas, wherein each luminous area is an EL “lamp.” A “thick film” EL lamp refers to one type of EL lamp and a “thin film” EL lamp refers to a different type of EL lamp. The terms only broadly relate to actual thickness and actually identify distinct disciplines. A thin, thick film EL lamp is not a contradiction in terms and such a lamp is considerably thicker than a thin film EL lamp. A “phosphor layer” is not restricted to a single phosphor and does not exclude cascading phosphors or dyes for color enhancement.

An EL lamp is essentially a capacitor having a dielectric layer between two conductive electrodes, one of which is transparent. The dielectric layer includes a phosphor powder or there is a separate layer of phosphor powder adjacent the dielectric layer. The phosphor powder emits light in the presence of a strong electric field, using very little current.

A modern EL lamp is a thick film device, typically including a transparent substrate of polyester or polycarbonate material having a thickness of about 7.0 mils (0.178 mm.). A transparent, front electrode of indium tin oxide (ITO) or indium oxide is vacuum deposited onto the substrate to a thickness of 1000 Å° or so. A phosphor layer is screen printed over the front electrode and a dielectric layer is screen printed over phosphor layer. A rear electrode is screen printed over the dielectric layer.

The inks used for making an EL lamp include a binder, a solvent, and a filler, wherein the filler determines the nature of the printed layer. A typical solvent is dimethylacetimide (DMAC) or ethylbutylacetate (EB acetate). The binder is typically a fluoropolymer such as polyvinylidene fluoride/hexafluoropropylene (PVDF/HFP), polyester, vinyl, or epoxy. A front electrode can be vacuum deposited (sputtered) ITO or ITO particles in an ink. A phosphor layer is typically deposited from a slurry containing a solvent, a binder, and zinc sulphide particles. A dielectric layer is typically deposited from a slurry containing a solvent, a binder, and barium titanate (BaTiO₃) particles. A rear (opaque) electrode is typically deposited from a slurry containing a solvent, a binder, and conductive particles such as silver or carbon. Because the solvent and binder for each layer are chemically the same or similar, there is chemical compatibility and good adhesion between adjoining layers.

Even though screen printing is a well developed technology and, therefore, relatively low in cost, there are disadvantages to screen printing. The resolution of screen printing is not as good as desired. For example, printing a fine line gap, e.g. 0.001″ wide, between conductors cannot be done reliably by screen printing adjacent conductors.

There are many uses for EL panels that require complicated patterns, e.g. displays such as instrument panels. Complicated patterns are presently obtained by patterning both the front electrode and the rear electrode of an EL panel and, occasionally, by combining several EL panels into one display. Such construction is costly, particularly because the patterned electrodes must be properly registered in order to produce the desired display.

Great expense is incurred in developing a prototype panel when the patterned rear electrode must be changed or adjusted. It is very desirable to be able to produce prototypes, or make small production runs, that are not significantly more expensive than mass produced panels. Material costs and time could be saved with a system that allowed changes to be made simply and immediately. Ideally, a design could be created on a computer and the xerographic print used as the pattern for an electrode.

It is known in the art to laminate lamp materials; see U.S. Pat. No. 5,808,412 (Zovko et al.) EL Panel Laminated to Rear Electrode, or U.S. Pat. No. 7,202,600 (Zovko et al.) Dimensionally Stable Electroluminescent Lamp without Substrate. As disclosed in the '412 patent, the lamp materials are thermally bonded to a printed circuit board or to a flex circuit. In this invention, a conductor is thermally bonded to the lamp materials.

It is known in the art to use a plurality of thermal pins in an array for printing; e.g. see U.S. Pat. No. 3,855,448 (Hanagata et al.). It is also known in the art to thermally print electrically conductive carbon black from a ribbon; e.g. see U.S. Pat. No. 4,269,892 (Shattuck et al.).

It is known to transfer a conductor thermally to a substrate, as disclosed in published application number US2007/0218378 A1.

In view of the foregoing, it is therefore an object of the invention to provide an EL panel in which the an electrode is thermally bonded to the lamp materials.

Another object of the invention is to provide an EL panel in which the rear electrode is thermally bonded to the lamp materials.

A further object of the invention is to provide an EL panel in which a patterned rear electrode is thermally bonded to the lamp materials.

Another object of the invention is to provide an EL panel in which a patterned rear electrode can be changed easily for prototype or low volume production.

A further object of the invention is to provide an EL panel in which the rear electrode is thermally bonded by toner powder.

Another object of the invention is to provide an EL panel in which the rear electrode is patterned directly from a xerographic print.

### SUMMARY OF THE INVENTION

The foregoing objects are achieved by the invention in which an EL panel includes a conductive layer that is thermally bonded to portions of the panel. A patterned rear electrode can be reconfigured easily for prototype or low volume production yet the method and apparatus are suitable for volume production as well. Toner powder can be used as an adhesive and the rear electrode can be patterned directly from a xerographic print.

### BRIEF DESCRIPTION OF THE DRAWINGS

A more complete understanding of the invention can be obtained by considering the following detailed description in conjunction with the accompanying drawings, in which:

FIG. 1 illustrates a ribbon having a thermally transferable conductive layer;

FIG. 2 illustrates, in cross-section, a method for bonding a conductive layer to electroluminescent lamp materials;

FIG. 3 illustrates, in cross-section, a method for bonding a conductive layer to electroluminescent lamp materials using toner powder as adhesive;

FIG. 4 illustrates, in cross-section, another method for bonding a conductive layer to electroluminescent lamp materials using toner powder as adhesive;

FIG. 5 illustrates bonding a rear electrode with the adhesive on the rear electrode;

FIG. 6 illustrates bonding a rear electrode with the adhesive on the dielectric layer; and

FIG. 7 is a perspective view of an article constructed using thermally adhered jumpers and bus bars for connecting shaped EL lamps to a source of power (not shown).

### DETAILED DESCRIPTION OF THE INVENTION

FIG. 1 illustrates a ribbon having a thermally transferable conductive layer, constructed as described in the application filed Nov. 30, 2005. Ribbon 10 is flexible but dimensionally stable and preferably includes registration guides, illustrated as sprocket holes 11 and 12. The registration guides can be optical rather than mechanical. The dimensions of the ribbon are determined by the intended use. In accordance with one aspect of this invention, wherein toner powder is used as an adhesive, the ribbon can be a standard size sheet of paper to facilitate handling by a xerographic printer. The printer can print fiduciary marks as registration guides at the same time that the pattern for the conductive layer is printed.

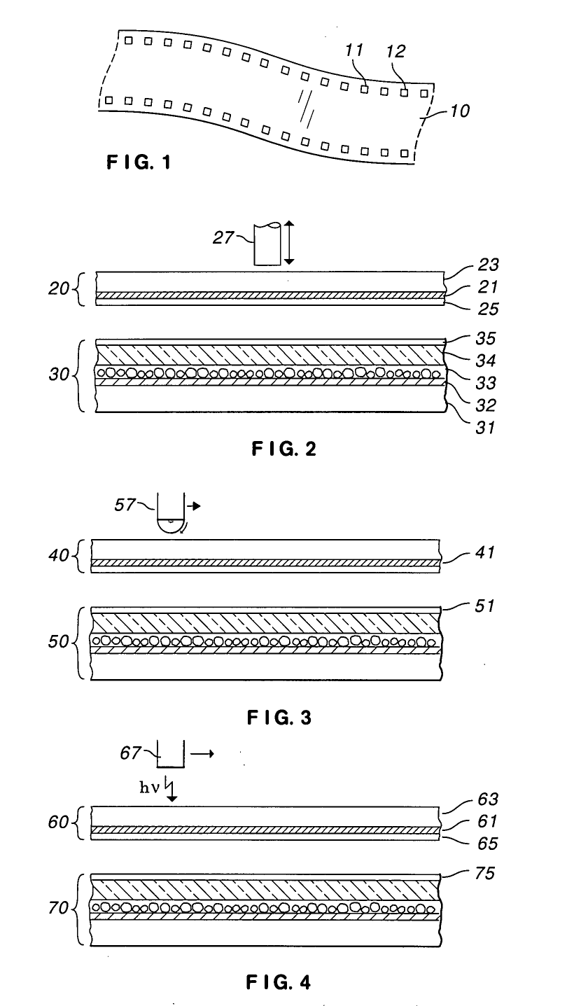

FIG. 2 illustrates a preferred method for bonding a conductive layer to electroluminescent lamp materials. In this embodiment of the invention, ribbon 20 includes conductive layer 21 overlying substrate 23 and adhesive layer 25 overlying the conductive layer. Conductive layer 21 is attached to substrate 23 by a release coat (not shown) that has the characteristic of being less adhesive than adhesive layer 25. Thus, when layer 25 is softened or activated by heat, conductive layer 21 will separate from substrate 23. Conductive layer 21 is a thin (on the order of thousands of angstroms) layer of metal.

Lamp materials 30 include substrate 31, transparent conductor 32, phosphor layer 33, and dielectric layer 34. Adhesive layer 35 is added to assure bonding to the conductive layer. The lamp materials can be deposited by screen printing or other method, such as roll coating. With substrate 31 operating roll to roll and being roll coated and with ribbon 10 operating roll to roll, EL lamps can be produced in considerable volume, yet have custom patterns.

Ribbon 20 and lamp materials 30 are illustrated in FIG. 2 as slightly spaced for clarity. For transfer, the two are brought together and heated pin 27 is brought down to transfer a portion of conductive layer 21 to lamp materials 30. Pin 27 is one of a plurality of pins, somewhat like in a dot matrix printer. The combination of heat and pressure effect the transfer. The pins can be actuated individually, thereby controlling the resulting pattern in conductive layer 21 when it adheres to lamp materials 30. The resolution of the pattern depends upon the diameter of the pins, which can be quite small; e.g. 0.005″.

FIG. 3 illustrates a method for bonding a conductive layer to electroluminescent lamp materials using toner powder as adhesive. In this embodiment, ribbon 40 is constructed in the same manner as ribbon 20. Patterned layer 51 of toner powder is applied to EL lamp materials 50, e.g. by printing on a separate sheet and laminating the sheet to the lamp materials or by printing on the lamp materials. For transfer, ribbon 40 brought into contact with patterned layer 51 and heated roller 57 is brought down to transfer a portion of conductive layer 41 to lamp materials 50. Heated roller need not be the same width (dimension into the drawing) as lamp materials 50 but preferably is the same width or wider than lamp materials 50.

FIG. 4 illustrates another method for bonding a conductive layer to electroluminescent lamp materials using toner powder as adhesive. In this embodiment, ribbon 60 includes, conductive layer 61 overlying substrate 63 and thermally activated adhesive layer 65 overlying the conductive layer. Adhesive layer 75 is the uppermost layer in lamp materials 70.

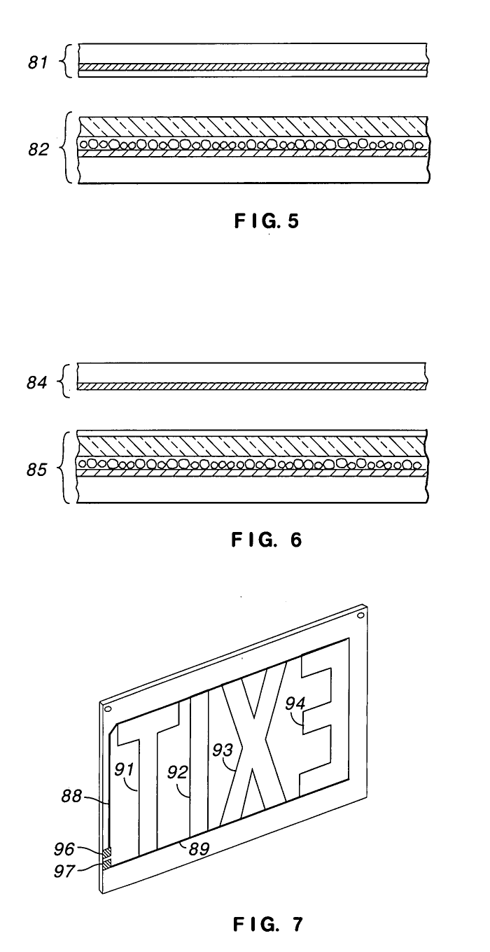

For transfer, ribbon 60 brought into contact with lamp materials 70 and transient heating is effected without pressure by laser 67, which scans the lamp materials, preferably in a raster pattern. In FIG. 5, ribbon 81 is brought into contact with lamp materials 82, which do not include an adhesive layer. In FIGS. 2, 3, 4, and 5, the adhesive layer on overlying the conductor can be patterned and formed xerographically; i.e. the adhesive is toner. The transfer re-melts the toner, causing the toner and the conductive layer to adhere to the lamp materials. In FIG. 6, ribbon 84 does not include an adhesive layer, which is included on lamp materials 85.

FIG. 7 illustrates an exit sign constructed in accordance with the invention. Specifically, thermally transferred conductors serve as bus bars 88 and 89. Thermally transferred rear electrodes also define letters 91, 92, 93, and 94 that are in contact with the bus bars. Contact pads 96 and 97 are also made by thermally transfer.

Depending upon use, letters or other graphics can be individually controlled to produce a desired effect. Also, depending upon the lit area of a lamp, a single bus bar can supply sufficient current. The bus bars can be spaced slightly from a lit area and coupled to the lit area by a jumper, i.e. by a conductive strip overlying an insulating layer. A jumper prevents the lit area from extending under a portion of the bus bar.

The invention thus provides an EL panel in which the an electrode is thermally bonded to the lamp materials. A patterned rear electrode can be changed easily for prototype or low volume production yet the method and apparatus are suitable for volume production as well. Toner powder can be used as an adhesive and the rear electrode can be patterned directly from a xerographic print.

Having thus described the invention, it will be apparent to those of skill in the art that various modifications can be made within the scope of the invention. For example, a hot platen laminator can be used instead of heated rollers when transferring a patterned toner powder. The bond between layers can be enhanced by treating a layer with an adhesion promoter; e.g. applying a thin coating of solvent to the outer surface of dielectric layer 34 rather than using adhesive layer 35. Although illustrated as producing a rear electrode, a thermally transferred layer can be deposited as bus bars on front electrode 32. The layer can be deposited before or after other lamp, materials are screen printed, for example. The means for effecting thermal transfer is not required by the particular lamp construction with which it is illustrated. Although raster scanning is preferred, other techniques can be used instead; e.g. vector plotting.

What is claimed as the invention is:

1. An electroluminescent panel characterized in that the panel includes a conductive layer thermally transferred to the panel and a layer of adhesive between the conductive layer and the panel, wherein the conductive layer is at least a portion of the rear electrode of said panel and the adhesive is thermally activated to attach the conductive layer to the panel.

2. The panel as set forth in claim 1 wherein the adhesive softens when heated.

3. The panel as set forth in claim 1 wherein said conductive layer is patterned to define at least two electroluminescent lamps.

4. The panel as set forth in claim 1 wherein a portion of said conductive layer is a bus bar on said panel.

5. The panel as set forth in claim 1 wherein a portion of said conductive layer is a contact area on said panel.

6. The panel as set forth in claim 1 wherein said adhesive includes toner for xerographic printing.

7. A method for applying a rear electrode to electroluminescent lamp materials, said method comprising the steps of:
contacting the lamp materials with a conductive layer and an adhesive;
selectively applying localized heat to the adhesive, causing the conductive layer to adhere to said lamp materials, forming said rear electrode.

8. The method as set forth in claim 7 wherein said adhesive is on the lamp materials.

9. The method as set forth in claim 7 wherein said adhesive is on the conductive layer, between the conductive layer and the lamp materials.

10. The method as set forth in claim 7 wherein said heat is applied by laser.

11. The method as set forth in claim 7 wherein said heat is applied by heated pin.
